(19) United States
(12) Patent Application Publication
(10) Pub. No.: US 2005/0072086 A1
(43) Pub. Date: Apr. 7, 2005

(54) Child safety door having door locking device

(76) Inventor: Cheol Wang Lim, Pusan (KR)

Correspondence Address: NOTARO AND MICHALOS, 100 DUTCH HILL ROAD, SUITE 110, ORANGEBURG, NY, 10962-2100, US

(21) Appl. No.: 10/770,662

(22) Filed: Feb. 3, 2004

(30) Foreign Application Priority Data
Sep. 23, 2003 (KR) 20-2003-0030025

(51) Int. Cl. E06B 3/70

(52) U.S. Cl. 52/455

(57) ABSTRACT

Disclosed is a child safety door having a door locking device, in which the child safety door is installed to a door frame of a house to safely keep a child indoors. The child safety door includes a rectangular door pivoted around a shaft rod and a door supporting frame coupled to the door for supporting the door. The child safety door includes a door locking device including a body having a knob at one side of the body, and a plurality of locking pins positioned in the body and restraining the door by resilience of a spring. The body has a pivoting plate engaged to the knob, an arm coupled to the pivoting plate, and an actuating plate coupled to the arm and pulling the locking pin to unlock the door.

### BACKGROUND OF THE INVENTION

1. Field of the Invention

The present invention relates to a child safety door installed to a common door frame, and more particularly, to a child safety door having a door locking device, in which the child safety door is installed to a door frame of a house to safely keep a child indoors.

2. Description of the Related Art

Generally, children are unable to suppress their curiosity. Therefore, they are constantly protected indoors by their protector, such as parents, so as to prevent a safety accident from being arisen by unexpected behaviors.

It is troublesome for their parents to constantly take care of children. Further, such care is inconvenient to their parents when managing household duties. For the reason, after the most of parents confine children to a room or a safety place, they manage the household duties. At that time, the children creep from the inside to thereby be in the face of danger, because of compulsion that children are confined to their room or fear that they are left along.

### SUMMARY OF THE INVENTION

Accordingly, the present invention is directed to a child safety door that substantially obviates one or more problems due to limitations and disadvantages of the related art.

It is an object of the present invention to provide a child safety door having a door locking device installed to various door frame of a house, in which a child cannot open a door due to the door locking device installed to the child safety door, thereby protecting the child indoors.

It is another object of the present invention to provide a child safety door, in which a locking pin of a door locking device is operated by resilience of a spring, so that the door locking device can automatically lock a door, when the door is closed.

If is another object of the present invention to provide a child safety door, in which an auxiliary locking device is separately installed to an upper end of the door locking device, so that the lock state of the door is more stably maintained.

To achieve these objects and other advantages and in accordance with the purpose of the invention, as embodied and broadly described herein, there is provided a child safety door including a rectangular door pivoted around a shaftrod and a door supporting frame coupled to the door for supporting the door, the child safety door comprising: a door locking device including a body having a knob at one side of the body, and a plurality of locking pins positioned in the body and restraining the door by resilience of a spring; the body having a pivoting plate engaged to the knob, an arm coupled to the pivoting plate, and an actuating plate coupled to the arm and pulling the locking pin to unlock the door.

The door is provided at a lower end thereof with a vertical locking pin for restraining the door using resilience of a spring, and the vertical locking pin is coupled to the pivoting plate via a wire and is vertically moved by the pivoting plate to unlock the door.

The child safety door further comprises an auxiliary locking device installed to an upper end of the door locking device. The auxiliary locking device includes a sliding plate moved along a guide rail protruded from the upper end of the door locking device so that a protrusion formed at the door supporting frame is inserted into the sliding plate to restraint the door; and a stopper inserted into the guide rail and inserted into a hole formed at the sliding plate by resilience of a spring to fix the sliding plate.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an installed state of a child safety door having a door locking device according to one preferred embodiment of the present invention;

FIG. 2 is an exploded view illustrating a door locking device and an auxiliary locking device shown in FIG. 1;

FIGS. 3a and 3b are views illustrating an operating state of the door locking device shown in FIG. 2;

FIG. 4 is a view illustrating an operating state of the auxiliary door locking device shown in FIG. 2;

FIGS. 5a and 5b are views illustrating a state of unlocking the auxiliary door locking device shown in FIG. 4; and

FIG. 6 is a view of a door locking device according to an alternative embodiment of the present invention.

### DETAILED DESCRIPTION OF THE PREFERRED EMBODIMENT

Reference will now be made in detail to the preferred embodiment of the present invention, an example of which is illustrated in the accompanying drawings.

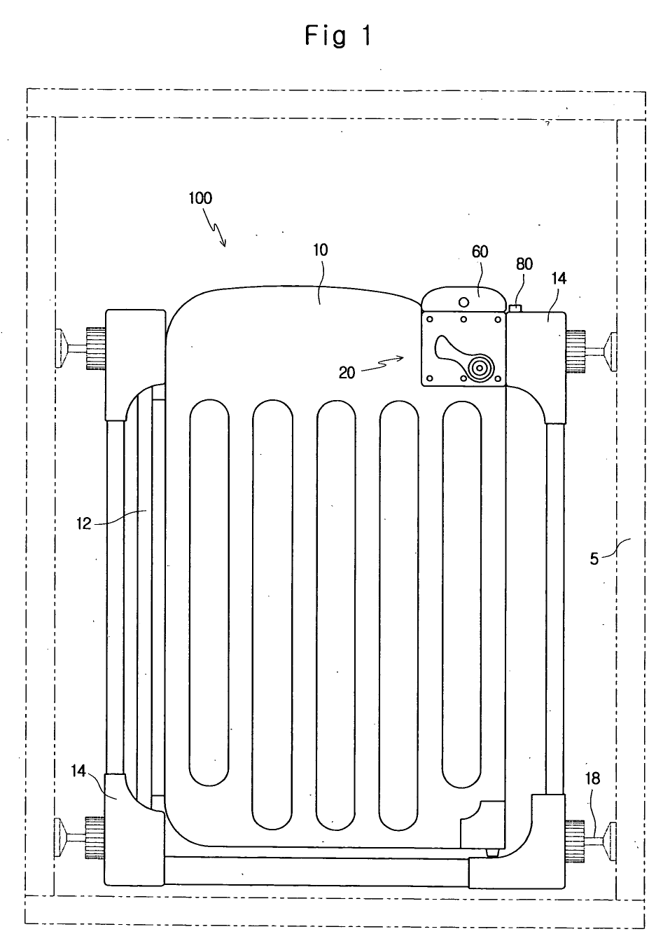

Referring to FIG. 1, a child safety door 100 having a door locking device according to one preferred embodiment of the present invention includes a rectangular door 10 pivoted around a shaft rod 12, and a door supporting frame 14 coupled to the door 10 for supporting the door 10. The child safety door 100 is installed to a door frame 5 for the access to a place of residence so as to confine the child to the room and thus easily protect the child indoors. Preferably, the door 10 has a half as many as a height of the door frame 5. The reason is that a protector can easily watch an internal state of the room to observe the behavior of the child, with the door 10 being closed. Preferably, the door 10 is adapted to be opened in both directions around the shaft rod 12. With the construction, the protector can easily open the door 10 when the protector comes out in company with the child.

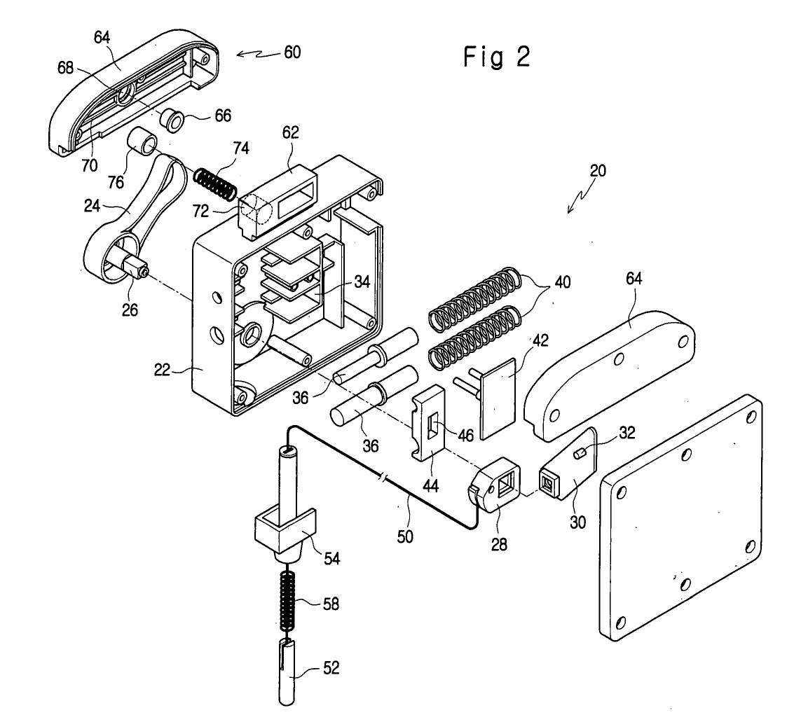

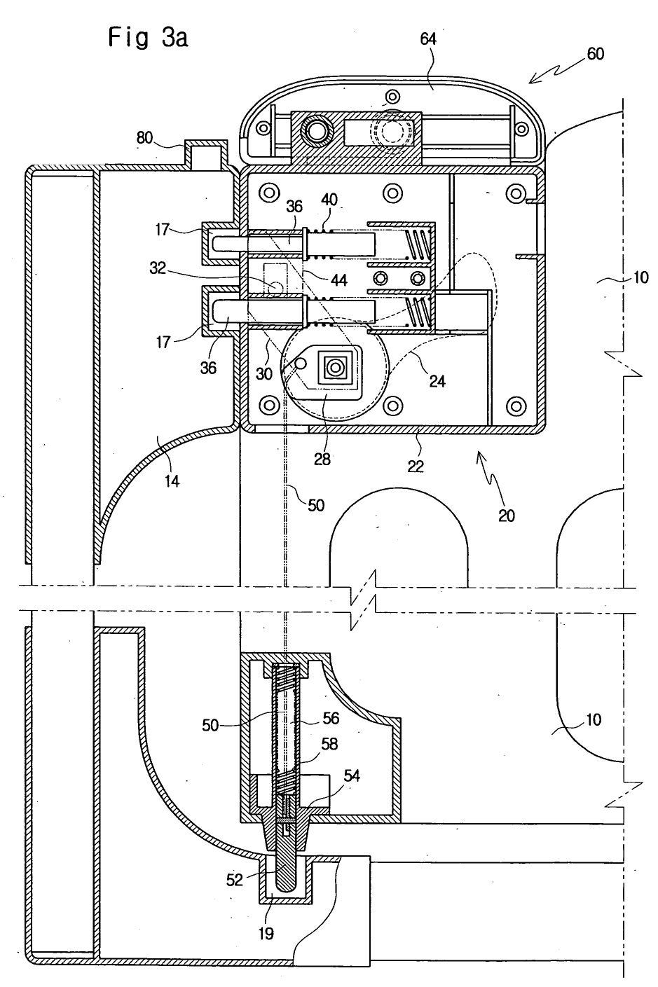

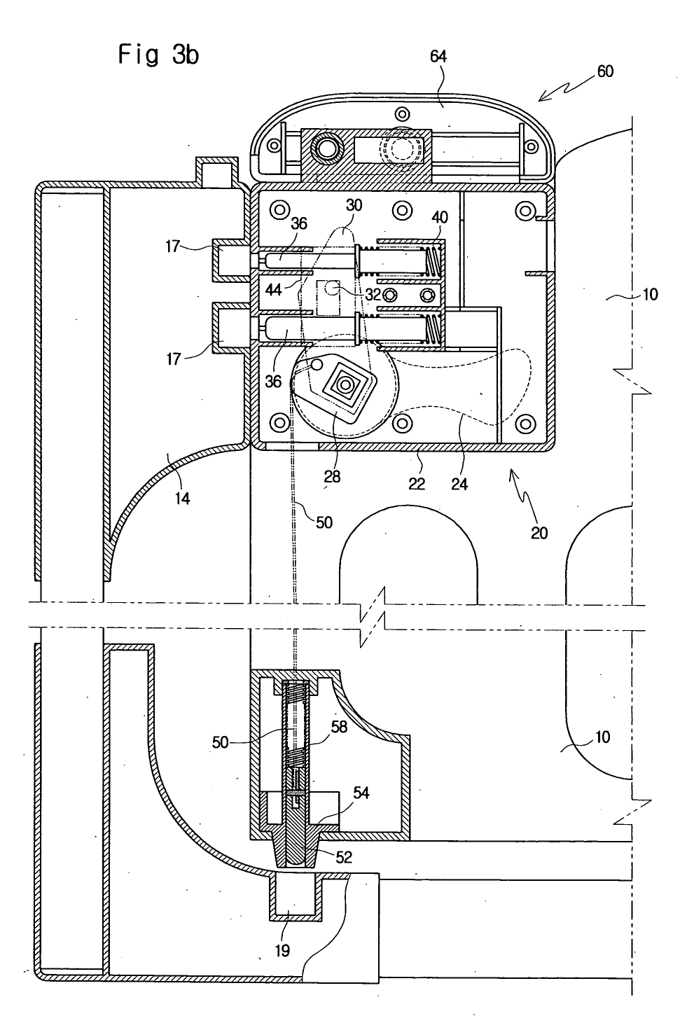

The door 10 is provided at one upper end thereof with a door locking device 20 so that the child does not open the door 10. The detailed construction of the door locking device 20 will now be described with reference to FIGS. 2 and 3a.

The door locking device 20 includes a body 22 having a knob 24 at one side of the body, and a plurality of locking pins 36 positioned between partitions 34 formed integrally with the body 22 and inserted into locking grooves 17 of the supporting frame 14 by resilience of a spring 40 for locking the door 10. The locking pins 36 are rearward moved by an actuating plate 44 moved horizontally by the knob 24 to unlock the door 10. The construction for coupling the actuating plate 44 and the knob 24 to actuate the locking pins will now be described.

A pivoting plate 28 and an arm 30 are moved to a rectangular rod 26 protruded from the knob 24, and are pivoted by the knob 24. A pin 32 protruded from a front end of the arm 30 is inserted into a recess 48 of the actuating plate 44 assembled to the locking pins 36, so that the actuating plate 44 is rearward moved by pivoting movement of the arm 30. Specifically, the licking pins 36 inserted into the locking grooves 17 to lock the door 10 are rearward moved by the pivoting plate 28 and the arm 30 pivoted by the operation of the knob 24 and the operating plate 44 coupled to the arm 30 and moved rearward by the arm, so that the locking pins are released from the locking grooves 17 to unlock the door 10.

The door is provided at one lower end thereof with a vertical locking pin 52 performing the same function as that of the locking pin 36. The detailed construction of the door locking device 20 will now be described with reference to FIGS. 2 and 3a.

As shown in FIGS. 2 and 3a, a bracket 54 with a space formed therein is fixed to the lower end of the door 10. The vertical locking pin 52 is mounted into the space 56 of the bracket 54, and is inserted into the locking groove 19 of the door 10 by the resilience of the spring 58 to lock the door 10. The vertical locking pin 52 is coupled to the pivoting plate 28 pivoted by the operating of the knob 24 via a wire, and is vertically moved by the rotation of the pivoting plate 28, so that the vertical locking pin is released from the locking groove 19 of the door 10 to unlock the door 10. Specifically, the vertical locking pin 52 is coupled to the pivoting plate 28 of the door locking device 20 via the wire 50, so that the vertical locking pin 52 is operated simultaneously with the pivot of the pivoting plate 28, upon the operation of the door locking device 20.

The locking pin 36 and the vertical locking pin 52 which are means for restraining the door 10 are adapted to be operated by the resilience of the springs 40 and 58. In the case of closing the door 10, the pins 36 and 52 are slid along an inclined surface (not shown) formed at the locking grooves 17 and 19 of the door supporting frame 14. Therefore, the door 10 is automatically locked, when the door is closed.

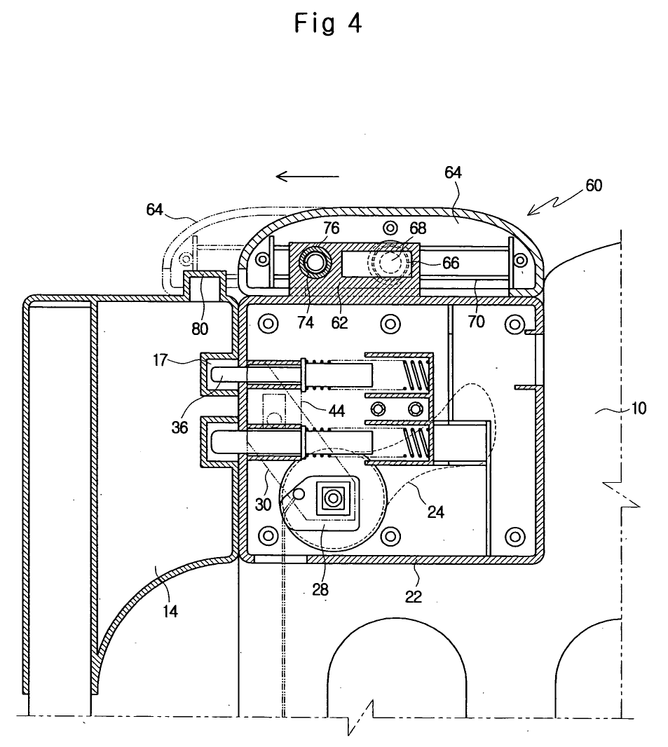

The door locking device 20 is provided at an upper end thereof with an auxiliary locking device 60, and the construction of the auxiliary locking device will now be described with reference to FIGS. 2 and 4.

The auxiliary locking device 60 includes a sliding plate 64 horizontally moved along a guide rail 62 protruded from the upper end of the door locking device 20. A protrusion 80 formed at the door supporting frame 14 is inserted into the sliding plate 64 to restraint the door 10. Further, a spring 74 and a stopper 76 are inserted into a groove 72 formed at the guide rail 62. The stopper 76 restraints the movement of the sliding plate 64 using the resilience of the spring 74. Specifically, if the sliding plate 64 is moved to restraint the door 10, the stopper 76 is inserted into a hole 68 formed at a center portion of the sliding plate 64 by the resilience of the spring 74 to thereby fix the sliding plate 64, with the stopper being contacted with the rail 70 of the sliding plate 64. The fixation of the sliding plate 64 causes the door 10 to restraint.

Preferably, the hole 68 is adapted to receive a separate pushing pin 66. The pushing pin 66 is inserted into the hole 68 to push down the stopper 76 restraining the siding plate 64 and thus release the stopper 76 from the hole 68, thereby unlocking the sliding plate 64.

Reference numeral 42 indicates a cover engaged to the partition 34 of the body 22 for preventing release of the spring 40.

The operation of the child safety door having the door locking device according to the present invention will now be described with reference to FIGS. 3a and 3b.

In the case of opening the door 10 always locked by the door locking device 20, the locking state of the door locking device 20 is released by operating the knob 24 of the door locking device 20 to open the door 10.

Specifically, if the knob 24 is operated, the pivoting plate 28 and the arm 30 engaged to the knob 24 are pivoted. Accordingly, the actuating plate 44 engaged to the arm 30 is rearward moved to pull the locking pin 36 inserted into the locking groove 17 of the door supporting frame 14, thereby easily unlocking the door 10 and thus open the door 10.

At that time, the vertical locking pin 52 restraining the door 10 installed to the lower end of the door 10 is also operated by the door locking device 20 to unlock the door 10. Specifically, the pivoting plate 28 is pivoted by the operation of the knob 24, and simultaneously the vertical locking pin 52 coupled to the pivoting plate 28 via the wire is pulled up by the pivoting plate 28 to leave from the locking groove 19 of the door supporting frame 14, thereby unlocking the door 10.

In case of closing the door 10 opened as described above, the locking pin 36 and the vertical locking pin 52 are automatically inserted into the locking grooves 17 and 19 formed at the door supporting frame 14 by the resilience of the springs 40 and 58, respectively, so that the door 10 is closed and the locking state is maintained.

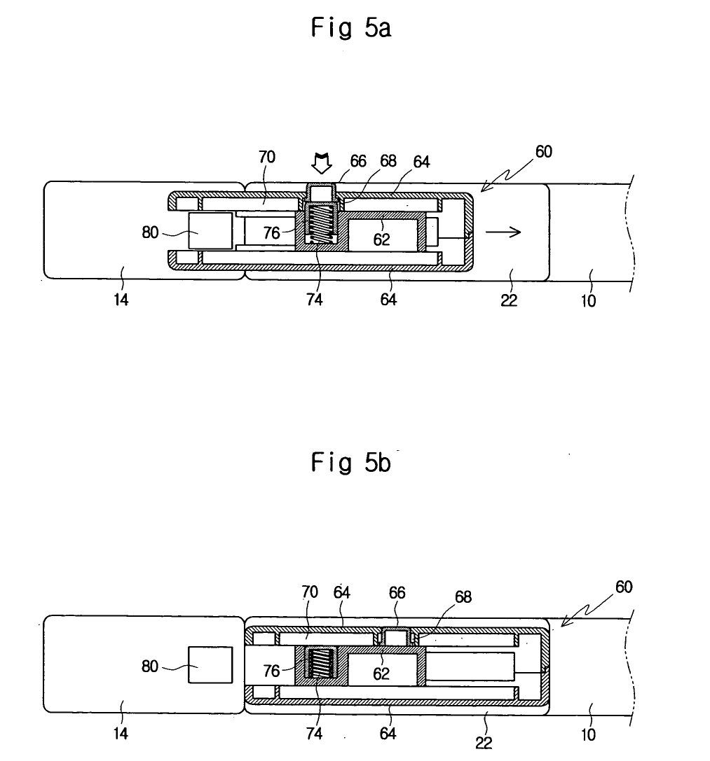

In the case the auxiliary locking device 60 is operated to more stably lock the door 10, if the sliding plate 64 is moved as shown in FIG. 4, the protrusion 80 formed on the upper end of the door supporting frame 14 is inserted into the sliding plate 64, thereby maintaining the locking state of the door 10. When the protrusion 80 is inserted into the sliding plate 64, the sliding plate is fixed by the stopper 76 inserted into the guide rail 62. Specifically, if the sliding plate 64 is moved in a left direction as shown in FIG. 5a, the stopper 76 is inserted into the hole 68 formed at the center portion of the sliding plate 64 by the resilience of the spring 74, thereby fixing the sliding plate 64.

In the case of releasing the auxiliary locking device 60 restraining the door 10, when the pushing pin 66 installed in the hole 68 of the sliding plate 64 is pushed down as shown in FIG. 5a, the stopper 76 inserted into the hole 68 is released from the hole. The unlocked sliding plate 64 is moved in a right direction as shown in FIG. 5b, thereby unlocking the door 10.

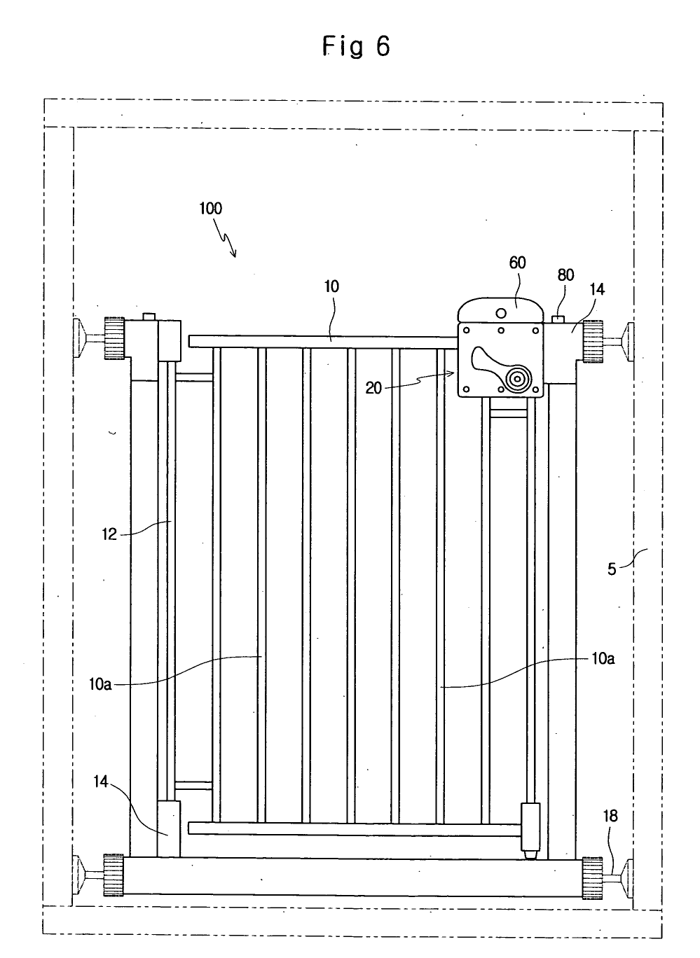

Referring to FIG. 6, the door 10 having the door locking device according to an alternative embodiment of the present invention includes a plurality of pipes 10a arranged at regular intervals, so as to reduce the cost thereof and simplify the manufacturing process.

With the above description, according to the present invention, a child safety door is installed to various door frame for allowing the access to a room, and a door locking device is installed to the child safety door, thereby protecting the child indoors.

Since a locking pin of the door locking device is operated by resilience of a spring, when the door is closed, the door locking device can automatically lock the door, thereby providing convenience of usage.

Further, an auxiliary locking device is separately installed to an upper end of the door locking device, so that the lock state of the door is more stably maintained. In addition, when the door locking device is out of order, the safety door can be locked by the auxiliary locking device.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A child safety door including a rectangular door pivoted around a shaft rod and a door supporting frame coupled to the door for supporting the door, the child safety door comprising:
a door locking device including a body having a knob at one side of the body, and a plurality of locking pins positioned in the body and restraining the door by resilience of a spring;
the body having a pivoting plate engaged to the knob, an arm coupled to the pivoting plate, and an actuating plate coupled to the arm and pulling the locking pin to unlock the door.

2. The child safety door as claimed in claim 1, wherein the door is provided at a lower end thereof with a vertical locking pin for restraining the door using resilience of a spring, and the vertical locking pin is coupled to the pivoting plate via a wire and is vertically moved by the pivoting plate to unlock the door.

3. The child safety door as claimed in claim 1, further comprising an auxiliary locking device installed to an upper end of the door locking device, the auxiliary locking device comprising:
a sliding plate moved along a guide rail protruded from the upper end of the door locking device so that a protrusion formed at the door supporting frame is inserted into the sliding plate to restraint the door; and
a stopper inserted into the guide rail and inserted into a hole formed at the sliding plate by resilience of a spring to fix the sliding plate.

4. The child safety door as claimed in claim 3, wherein a pushing pin is inserted into the hole for pushing the stopper to release fixation of the sliding plate.
